(19) United States
(12) Patent Application Publication
(10) Pub. No.: US 2009/0119233 A1
(43) Pub. Date: May 7, 2009

(54) Power Optimization Through Datacenter Client and Workflow Resource Migration

(75) Inventors: John Dunagan, Bellevue, WA (US); James R. Hamilton, Bellevue, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 11/934,933

(22) Filed: Nov. 5, 2007

(51) Int. Cl. G06F 17/30

(52) U.S. Cl. 705/412

(57) ABSTRACT

Systems and methods for power optimization through datacenter client and workflow resource migration are described. In one aspect, the systems and methods estimate how much power will cost for different and geographically distributed datacenters to handle a specific set of actual and/or anticipated workflow(s), where the workflow(s) are currently being handled by a particular one of the distributed datacenters. These estimated power costs are based on current power prices at each of the datacenters, and prior recorded models of power actually used by each of the datacenters to handle similar types of workflows for specific numbers of client applications. If the systems and methods determine that power costs can be optimized by moving the workflow(s) from the datacenter currently handling the workflows to a different datacenter, service requests from corresponding client applications and any data resources associated with the workflows are migrated to the different datacenter.

### BACKGROUND

Recent trends illustrate a shift from large mainframe computing to commodity clusters of servers in datacenters. A datacenter may contain many thousands of servers to provide services for millions of users. Servers and other equipment in a datacenter are typically racked up into cabinets, which are then generally organized into single rows forming corridors between them. To address the excessive heat typically generated by electronic equipment in such confined spaces, the physical environments of datacenters are strictly controlled with large air conditioning systems. All of this datacenter equipment needs to be powered. Of central concern is the rapidly rising energy use of datacenters, which can be prohibitively expensive and strain energy resources during periods of heavy power usage.

### SUMMARY

Systems and methods for power optimization through datacenter client and workflow resource migration are described. In one aspect, the systems and methods estimate how much power will cost for different and geographically distributed datacenters to handle a specific set of actual and/or anticipated workflow(s), where the workflow(s) are currently being handled by a particular one of the distributed datacenters. These estimated power costs are based on current power prices at each of the datacenters, and prior recorded models of power actually used by each of the datacenters to handle similar types of workflows for specific numbers of client applications. If the systems and methods determine that power costs can be optimized by moving the workflow(s) from the datacenter currently handling the workflows to a different datacenter, service requests from corresponding client applications and any data resources associated with the workflows are migrated to the different datacenter.

This Summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

### BRIEF DESCRIPTION OF THE DRAWINGS

In the Figures, the left-most digit of a component reference number identifies the particular Figure in which the component first appears.

FIG. 1 shows an exemplary system for power optimization through datacenter client and workflow resource migration, according to one embodiment.

FIG. 2 shows further exemplary aspects of a datacenter of FIG. 1 for power optimization through datacenter client and workflow resource migration, according to one embodiment.

FIG. 3 shows an exemplary procedure for power optimization through datacenter client and workflow resource migration, according to one implementation.

FIG. 4 shows another exemplary procedure for power optimization through datacenter client and workflow resource migration, according to one implementation.

### DETAILED DESCRIPTION

### Overview

Systems and methods for power optimization through datacenter client and workflow resource migration are described. A system with multiple datacenters may be geographically distributed, for example, with a first datacenter in one region, a second datacenter in a different region, and so on. Energy costs and energy availability often differ across geographic regions and time of day. Power is typically charged on a percentile basis and the charge is often tiered by time of day with power being cheaper at the utilities non-peak load periods. Thus, an opportunity for arbitrage may exist when datacenter providers need capacity. Additionally, for any one particular datacenter, energy amounts needed to handle workflows for one type of client application (e.g., an instant messaging (IM) client, etc.) may differ from energy amounts required to handle workflows for a different type of client application (e.g., a search client, etc.). Moreover, actual amounts of power used by any one particular datacenter to handle a set of workflows are generally a function of the datacenter's arbitrary design, equipment in the datacenter, component availability, etc. For example, datacenter design dictates power loses in distribution and the costs to cool. For a given workload, the servers need to a certain amount of work. Different serves have different efficiency and so the amount of critical load required to get the work done varies on the basis of 1) server efficiency (how efficient critical load is utilized) and 2) data center power and mechanical system efficiency. As a result, different datacenters may consume different amounts of power to handle the same type and quantity of workflow (workflow type and quantity being a function of the client application type and the number of workflows being handled by the datacenter for applications of that type).

In view of the above, and in a system of datacenters, part of power optimization involves optimizing costs by objectively selecting one or more specific datacenters to handle actual and/or anticipated workflows across numerical ranges of differentiated clients. In this implementation, when costs to handle one datacenter's ongoing or anticipated workflows can be optimized by handling the workflows at a different datacenter, the datacenter redirects client applications and any resources associated with the workflows, to the different datacenter. Of course, while there are many other aspects to this system, in one implementation, for example, algorithms of these systems and methods reside in datacenter components including a datacenter workflow migration manager, back-end servers, front-end servers, and a partitioning manager (e.g., a datacenter lookup service) that lies logically below a network load balancer and between the front and back-end servers.

These and other aspects of the systems and methods for power optimization through datacenter client and workflow resource migration are now described in greater detail.

### An Exemplary System

Although not required, the systems and methods for power optimization through datacenter client and workflow resource migration, according to one embodiment, are described in the general context of computer-program instructions executed by a computing device such as a personal computer. Program modules generally include routines, programs, objects, components, data structures, etc., that perform particular tasks or implement particular abstract data types. While the systems and methods are described in the foregoing context, acts and operations described hereinafter may also be implemented in hardware.

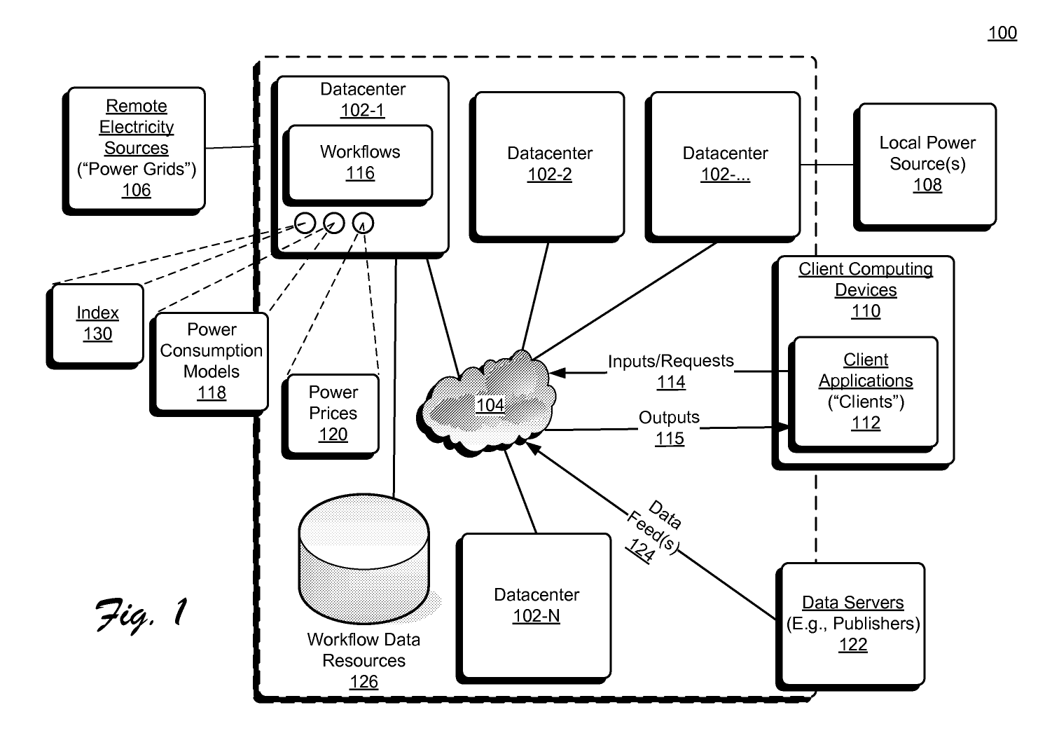

FIG. 1 shows an exemplary system 100 for power optimization through datacenter client and workflow resource migration, according to one embodiment. In this implementation, system 100 includes datacenters 102-1 through 102-N operatively coupled to one another over a communication network 104 such as the Internet, an intranet, etc. There can be any arbitrary number of datacenters 102 in the system as a function of a particular configuration of the system. Electrical power to the datacenters is provided by one or more remote power source(s) 106 (e.g., hydroelectric power plant(s), etc.) and/or local power source(s) 108 (e.g., power generators, battery repositories, etc.). The dotted box encapsulating datacenters 102-1 through 102-N represents a power grid provided by remote power source(s) 106. In one implementation, one or more of the datacenters 102 are outside of the power grid.

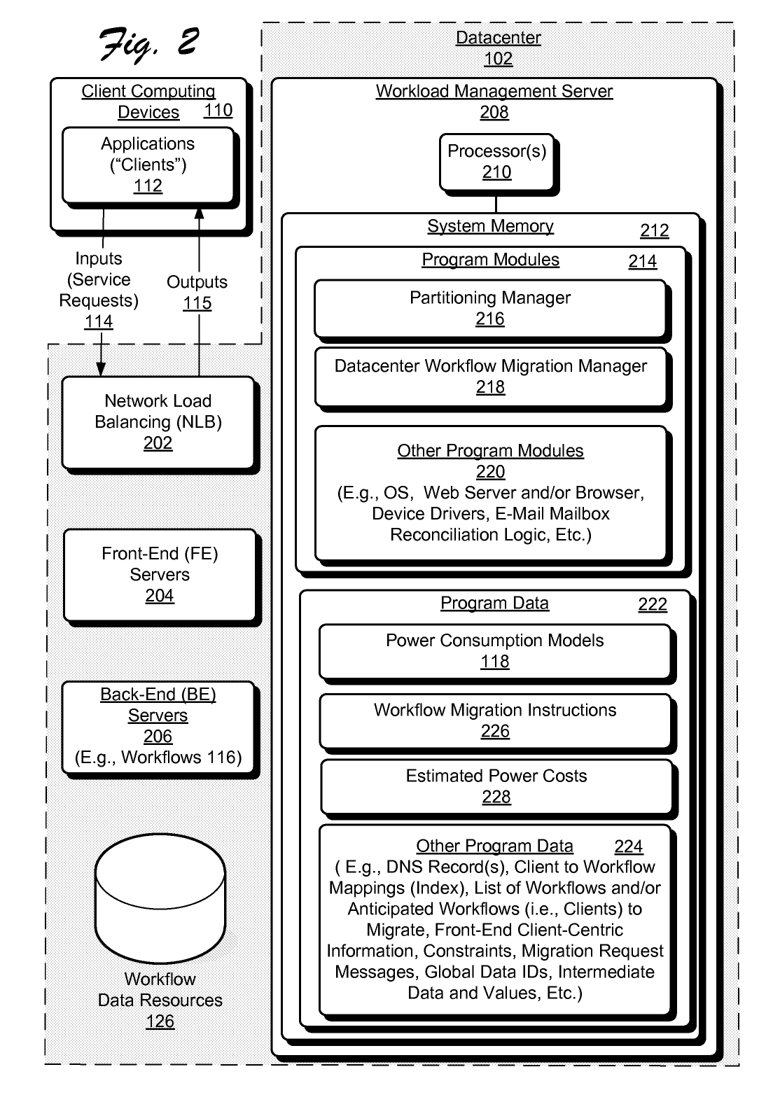

Client computing devices 110 are coupled to respective ones of datacenters 102 via the communication network 104. Such a client computing device 110 represents, for example, a general purpose computing device, a server, a laptop, a mobile computing device, and/or so on, that accepts information in digital or similar form and manipulates it for a result based upon a sequence of instructions. In one implementation, one or more such client computing devices are internal to a datacenter, rather than being external to the datacenter as shown in FIGS. 1 and 2.

Referring to FIG. 1, client applications (“clients”) 112 executing on respective ones of the computing devices 110 send inputs 114 over the network to one or more of the datacenters. Such clients 112 include, for example, IM applications, search applications, browser applications, etc. Inputs 114 can be in a variety of forms. In one implementation, for example, inputs 114 include one or more arbitrary service request types (e.g., IM requests from IM applications, search requests from search applications, rendering requests, information retrieval/storage requests, and/or so on). In this implementation, there can be any number of arbitrary service request types as a function of the particular types of clients 112 sending the inputs. Responsive to datacenter 102 receipt of inputs, the datacenter performs work, shown as workflows 116 (i.e., computer-program process flows), to generate corresponding outputs 115. For example, datacenter processing of IM request(s) 114 from IM client(s) 112 results in IM workflow(s) 116, datacenter processing of search request(s) 114 received from search client(s) 112 results in search workflow(s) 116, etc.

### Exemplary Power Consumption Models

For power optimization through datacenter client and workflow resource migration, respective “power consumption models” 118 (“models 118”) are configured and maintained for at least two of the datacenters 102 in system 100. The models 118, for any particular datacenter, indicate power consumed by that particular datacenter to process workflows 116 for specific numbers (e.g., numerical ranges) of client applications 112, where the client applications are differentiated by client type (e.g., IM clients, search clients, rendering and caching clients, and/or so on). Each datacenter's power consumption models are further configured, as described below, to identify power consumed by one or more different datacenters in the system 100 to process workflows across numerical ranges of differentiated client applications (e.g., 10,000 IM clients 112, 20,000 IM clients, . . . , 1,000,000 IM clients, 10,000 search clients, 20,000 search clients, and/or so on). As indicated above and as described in greater detail below, this allows a datacenter 102 to determine part of a power optimization algorithm to determine whether a set of the datacenter's clients 112 and any data resources 126 associated with a particular set of workflows 116 should be migrated/handled by a different datacenter 102.

In one implementation, an administrator measures a datacenter's power consumption to create models 118 by sending z units of service request traffic (i.e., inputs 114) from a client 112 of particular type to the datacenter, causing corresponding numbers of workflows 116. The administrator collects and maps data indicating how datacenter power use changes to handle workflows 116 for specific numbers (e.g., numerical ranges) of clients 112, where the clients are differentiated by type (e.g., IM clients, search clients, etc.). The administrator can then move those z units away to stop corresponding workflows 116, and send y units of different traffic (e.g., search requests) to implement workflows 116 of a different type. Power use to handle the y units is measured and mapped based on the corresponding numbers and type of clients 112 used to generate the y units. For example, a model 118 may indicate that a datacenter uses 1 kWh (kilowatt hour) of power to process workflows for 1 million IM clients, 2 kWh of power to process workflows for 2 million IM clients, 0.5 kWh of power to process workflows for 500,000 search clients, and/or so on.

Exemplary power consumption models 118 are shown in TABLE 1. In one implementation, power consumption model 118 is formatted as one or more of ASCII strings, using Extensible Markup Language (XML), etc.

TABLE 1
EXEMPLARY POWER CONSUMPTION MODEL DATA

| | | |
|---|---|---|
| Measured Power Use | Client Type | Number of Clients |

DATACENTER 102-1

| | | | | |
|---|---|---|---|---|
| (a) | 0 | | None (N/A) | 0 |
| (b) | .75 | kWh | IM Clients | 1 × 10⁶ |
| (c) | 1.0 | kWh | IM Clients | 1.25 × 10⁶ |
| (d) | .50 | kWh | Search Clients | 2 × 10⁶ |
| (e) | 3 | kWh | Differentiated Internal | 3 × 10³ |
| | | | Datacenter Task | |

. . .
DATACENTER 102-2

| | | | | |
|---|---|---|---|---|
| (a) | 0 | | None (N/A) | 0 |
| (b) | 1.0 | kWh | IM Clients | 1 × 10⁶ |
| (c) | 1.5 | kWh | IM Clients | 1.25 × 10⁶ |
| (d) | .25 | kWh | Search Clients | 1.5 × 10⁶ |
| (e) | 2 | kWh | Differentiated Internal | 1 × 10³ |
| | | | Datacenter Task | |

. . .
DATACENTER 102- . . .

. . .

TABLE 1 shows models of power consumption for several datacenters 102 in system 100 of FIGS. 1 and 2. In this implementation, for example, for any particular datacenter, a model maps “Measured Power Use” to “Client Type” and “Number of Clients” of that particular type. There are many known tools to measure power consumption (e.g., a Wattmeter, utility meter monitoring, etc.). In another example, power distribution equipment, individual server power supplies, etc., can be fully instrumented, so that power consumption can be gathered from multiple levels the a datacenters power distribution system. Referring, for example, to the power consumption model for datacenter 102-1, line (a) of TABLE 1 shows that when datacenter 102-1 is not servicing any clients 112 (e.g., the datacenter is not yet online), datacenter 102-1 uses 0 kWh of power. Line (b) of this example shows datacenter 102-1 uses 0.75 kWh of power to process workflows 116 for 1×10⁶ IM clients 112. Line (c) of this example shows that datacenter 102-1 uses 1.0 kWh of power to process workflows for 1.25×10 ⁶ IM clients. Line (d) of this example shows that datacenter 102-1 uses 0.75 kWh of power to process search workflows 116 for 2×10⁶ search clients 112, etc. Line (e) of this example shows that datacenter 102-1 uses 3 kWh of power to process internal datacenter workflows 116 (workflows implemented by the datacenter independent of a client 112) for 2×10⁶ datacenter-based clients 112, etc.

In one implementation, for example, when an administrator measures datacenter power use to identify power use trends of the datacenter, the administrator does not increase datacenter power consumption, for example, from 0% power consumption all the way to 100% power consumption. But rather, enough workflow 116 is generated to increase power consumption to some percentage (e.g., 10%) of datacenter power use capacity. In this scenario, the datacenter can utilize linear extrapolation to estimate corresponding power consumption to handle workflows for different numbers of type-differentiated client applications. For example, 10 times the number of clients of a particular type will result in 10 times the energy consumption. In one implementation, datacenter power use estimation operations assume linear power consumption scaling once a configurable threshold is crossed (e.g., z units of traffic require ten (10) servers at full power, 2*z units of traffic require twenty (20) servers at full power, etc.). In another implementation, non-linear power consumption scaling is modeled. For example, once the energy consumed by all servers running at 50% of capacity is known, it may be appropriate to estimate the energy required to serve more requests as rising with the square of the overall utilization, so that running at 100% capacity would require 4 times the power of running at 50% capacity. The choice of a particular linear or non-linear model is dictated by the particulars of how the datacenter handles a given workload.

Accordingly, each datacenter 102 is configured with a respective power consumption model 118 that indicates actual historical power consumption by that datacenter to process workflows 116 for specific numbers of type-differentiated clients 112. Each datacenter shares or communicates this configured datacenter-centric information to each other datacenter 102 in the system 100. In this manner, each datacenter has modeled information pertaining not only to its particular power consumption, but also information (i.e., respective models 118) indicating respective power consumption of other datacenters 102 to process particular workflows 116 for respective types of differentiated clients 112. In view of identified power prices in geographic regions where datacenters 102 are located, a datacenter uses power consumption models 118 to periodically estimate its respective power consumption and power costs to process a set of ongoing or anticipated workflows 116, as compared to power costs were the same ongoing or anticipated workflows to be processed remotely (i.e., at one or more different datacenters 102).

### Exemplary Workflow Power Cost Estimations

Each datacenter 102 in the system obtains and periodically updates information for power prices 120 to identify prices/rates of power at respective geographic areas associated with at least a subset of the datacenters 102 in the system 100. For example, datacenter 102-1 may be served by a first power grid 106 and datacenter 102-2 may use power from a different power grid 106, where prices of power from the first grid are not equal to power prices from the second grid, prices from a local power source 108 may be less, etc. In one implementation, for example, a datacenter 102 periodically receives such information from a data server 122 (e.g., a publisher in a publisher subscriber context) via data feed(s) 124. In one implementation, for example, such server(s) 122 also provide a datacenter 102 with other price information, for example, network access prices, etc. A datacenter 102, using it's respective power consumption model 118 in view of geographical power prices/rates 120 (and possibly other prices or costs) and the power models 118 of other datacenters, estimates power costs to process sets of workflows 116 for type-differentiated clients 112 (i.e., clients that are type-differentiated). That is, the datacenter uses the identified power prices and the information in corresponding power consumption models 118 to periodically estimate power consumption and associated power costs to process: (1) a set of actual and/or forecast workflows 116 locally; and (2) such workflows at one or more different datacenters 102.

In one implementation, for example, a datacenter 102 performs linear extrapolation of the information in models 118 to estimate amounts of power needed to process a set of workflows for a specific number of clients differentiated by client type, For example, if the datacenter is handling workflows for 4 million IM clients 112 and the datacenter's respective power model 118 indicates that the datacenter previously used 2 kWh to process workflows for 2 million IM clients 112, the datacenter extrapolates that it will use 4 kWh to process corresponding workflows for 4 million IM clients 112. Using this power use estimate, the datacenter calculates corresponding local and/or remote power costs using the maintained list of geographic power prices/rates 120. If estimated power costs to process a particular set of the datacenter's workflows 116 are determined to be one or more of cheaper, more readily available (e.g., independent of price), etc., at a different datacenter 102, the datacenter migrates specific clients associated with the particular workflows, as well as any resources 126 used to implement the workflows, to the different datacenter. Such data resources are arbitrary and may include, for example, databases, calculations, e-mail mailboxes, user spaces, web pages with pure content, data that is in datacenters and not exposed to clients (e.g., data about client activity on the Internet, search patterns, and corresponding computations on such data), etc.

In one implementation, it is assumed that a target datacenter 102 to which client(s) 112 associated with the particular workflows and any corresponding resources 126 are to be migrated from an originating/transferring datacenter 102, has the processing resources (e.g., server capacity, etc.) to handle the transferred clients/data resources. In another implementation, the target datacenter evaluates, for example, available processing resources, etc. to determine whether to accept a set of clients, data resources, and corresponding workloads from the transferring datacenter. Part of this latter implementation takes into consideration that workloads have peaks and valleys. A datacenter that accepts the migrated clients, etc., should have enough IT equipment, power, and cooling to handle the peaks. The target datacenter may not be handling a peak load, and therefore, have excess capacity to accept the migrated clients, data resources, and/or so on. In this scenario, system 100 optimizes where to host the workload in non-peak periods across the available resources. That is, system 100 provides dynamic workload management on the basis of unequal power charging/costs/rates and unequal IT equipment and data center efficiency.

### Exemplary Operations for Client and Workflow Resource Migration

In one implementation, a datacenter 102, responsive to determining that power can be optimized by migrating a set of clients 112 and any resources 126 associated with a set of actual and/or anticipated workflows to a different datacenter 102, notifies the clients 112 to send all subsequent and corresponding service requests 114 to the different datacenter. To identify client(s) 112 associated with the actual and/or anticipated workflows, each datacenter 102 (e.g., front-end servers) creates and/or maintains a respective index 130 mapping respective type-differentiated clients 110 (e.g., via IP addresses, port numbers, etc.) to associated ongoing and/or anticipated workflow(s) 116 in the datacenter. An exemplary such index 130 is shown in TABLE 2.

TABLE 2
EXEMPLARY CLIENT, WORKLFOW,
AND CLIENT TYPE MAPPINGS

| | | |
|---|---|---|
| Client A | Workflow(s) A, B, C, . . . | Client Type: IM Application |
| Client B | Workflow(s) D, E, . . . | Client Type: Rendering App. |
| Client C | Workflow(s) F, . . . | Client Type: Search App. |
| . . . | . . . | . . . |

Anticipated requests 114 from clients 112 can be moved from one datacenter to a different datacenter, for example, by redirecting the clients to the different datacenter. In one implementation, for example, IM clients, search clients, or any web browser consuming a service can be redirected to a different datacenter through domain name system (DNS) operations. This technique is standard today in Content Distribution Networks. To this end, a datacenter 102 publishes a DNS record for client requested service(s) (e.g., IM service, search service, rendering and caching service, etc.) in a subset of the Internet that contains the IP address of the different datacenter. The client will subsequently learn of this new IP address when its DNS record needs to be refreshed, and the client asks the DNS service for a new record. In one implementation, for example, the IP address of the different datacenter is the IP address of the datacenter's network load balancer, although it could also be the IP address of a different component. After reading the new DNS record, the clients 112 then send corresponding requests 114 to the different datacenter. For instance, if the client type is a search client, then the datacenter publishes a DNS record for a search service in the different datacenter. After reading the new DNS record, the clients (e.g., web browsers, etc.) will then begin sending search requests 114 to the different datacenter. In another implementation, a client 112 is directed via a command (shown as a respective output 115) to begin communicating (sending all subsequent and corresponding service requests 114) with the different datacenter using, for example, the SIP (Session Initiation Protocol) or known extensions of SIP.

In another implementation, responsive to determining that power considerations can be optimized by migrating a set of workflows 116 to a different datacenter 102, a datacenter 102 (e.g., a front-end server in the datacenter, please see FIG. 2) migrates clients 112 and any corresponding workflow resources 126 without involving clients external to the datacenter. In one exemplary such scenario, the work being migrated by the datacenter corresponds to a set of internal datacenter tasks of arbitrary task-type, e.g., recalculating global relative popularity of web pages after having re-crawled the internet, etc. To accomplish this, the datacenter, will first move at least a subset of the data on which such tasks need to run to the different datacenter. Once this is done, the internal datacenter client application is redirected to being sending requests for such workflows to the different datacenter.

### Exemplary Workflow Resource Transfers

In one implementation, when a datacenter 102 migrates a set of clients 112 associated with a set of workflows 116 to different datacenter 102, where appropriate, the datacenter also migrates any data resources used by the workflows 116 not currently available to the different datacenter, to the different datacenter. Data resource(s) 126 can be transferred to the different datacenter using any one or more different arbitrary protocols such as HTTP, protocols for balancing workload between data centers (e.g., DNS updates with short TTL, redirection, etc.), etc. Such resources are arbitrary since they are a function of the particular types of workflows being migrated. For example, if the workflows utilize one or more resources including mailboxes, databases, calculations, internet crawl results from internal datacenter tasks, etc., the resource(s) are also migrated to the different datacenter. Consider, for example, a search client 112 that sends a datacenter 102 search request(s) 114. In this example, a corresponding workflow data resource 126 is a web index. In this scenario, the datacenter to which the search client is being moved may also have a copy of such a web index, so resource movement in this example may not be necessary. In another example, if the client is an e-mail service client, it is likely that the mailbox associated with the client will also need to be moved to the new datacenter. Datacenter 102 uses known techniques such as conventional lookup services to map clients to specific mailboxes/resource locations.

In another example, migrating client 112 IM traffic to another datacenter may be accomplished by datacenter 102-1 sending a client 112 an explicit command “start talking to datacenter 102-2” command (e.g., via the SIP protocol, etc.) In this exemplary scenario, a back-end server in datacenter 102-1 may move the client's data from datacenter 102-1 to datacenter 102-2. This part of the migration operation is done independent of the client. In one implementation, the data being moved includes the client's presence information (e.g., an IP address, an indication of whether to use some relay for other client(s) to connect to the client, whether the client is busy/available/etc.) and the set of other applications (e.g., buddies) that need to be notified when that client's presence changes. The particular protocol used to migrate data resources is arbitrary, for example, the HTTP protocol, etc. In one implementation at the application level, a back-end server sends a single message to the datacenter receiving the data, for example, with a header indicating: “Dear datacenter, here is a package containing both client data and client inputs. This belongs to you now.”

In an exemplary implementation, the mailboxes, instant messaging data and/or other resources 126 are identified by a unique global identifier (shown in FIG. 2) that corresponds to the user's identity within the datacenter environment. Within a datacenter 102, the mapping of a user request 114 to this mailbox uses a lookup service that will return the location of the mailbox. If the user mailbox does not exist in the datacenter, the lookup service may instead determine the appropriate datacenter where the mailbox now resides, for example, by consulting an index that is replicated across all the datacenters. Such replicated indices are known and available for use. To migrate a resource such as a user mailbox, the datacenter giving the mailbox away may takes steps such as copying the files that correspond to the user mailbox to the new datacenter 102, deleting the files once they are known to have been received, and updating the replicated index to indicate that the new datacenter now owns the user's mailbox.

When a receiving datacenter 102 receives a new mailbox or other data resource 126, it allows the file representing the resource to be copied into an appropriate location within the datacenter. The receiving datacenter then waits for the replicated index to be updated, indicating that the mailbox has been moved to the receiving datacenter. In one implementation, if the receiving datacenter does not see an update in the replicated index after some configurable period of time, the datacenter executes reconciliation logic (FIG. 2) to determine the actual owner of the mailbox. In one implementation, the reconciliation logic, for example, contacts a distinguished datacenter 102 that serves as the long-term authority for user mailbox location.

### An Exemplary Datacenter Configuration

FIG. 2 shows further exemplary aspects of a datacenter 102 of FIG. 1 for power optimization through datacenter client and workflow resource migration, according to one embodiment. For purposes of exemplary description and illustration, aspects of the datacenter are described with respect to FIG. 1. In the description, the left-most number of a component/data reference numeral indicates the particular figure where the component/data was first introduced. For example, datacenter 102 represents any of datacenters 102-1 through 102-N in system 100 of FIG. 1. In other examples, computing devices 110 and applications (“clients”) 112, both aspects having reference numerals starting with “1”, were also first introduced in FIG. 1, and so on. For purposes of exemplary illustration of discussion, datacenter 102 of FIG. 2 represents an arbitrary one datacenter 102-1 through 102-N of FIG. 1.

Referring to FIG. 2, and in this exemplary implementation, datacenter 102 provides power optimization through datacenter client and workflow resource migration using the following components: network load balancing/balancer (NLB) logic 202, front-end servers 204, back-end servers 206, and workflow management server 208. In one implementation, components 202 through 208 represent a combination of physical components and logical abstractions. Each component 202 through 208 is implemented on a respective computing device/server that accepts information in digital or similar form and manipulates it for results based upon a sequence of computer-program instructions. A computing device includes one or more processors coupled to a tangible computer-readable data storage medium. A processor may be a microprocessor, microcomputer, microcontroller, digital signal processor, etc. The system memory includes, for example, volatile random access memory (e.g., RAM) and non-volatile read-only memory (e.g., ROM, flash memory, etc.). System memory includes program modules. Each program module is a computer-program application including computer-program instructions for execution by a processor.

Referring, for example, to workflow management server 208, the server includes one or more processors 210 coupled to system memory 212 (i.e., one or more tangible computer-readable data storage media). System memory 212 includes program modules 214, for example, partitioning manager 216, datacenter workflow migration manager 218, and “other program modules” 220 such as an Operating System (“OS”) to provide a runtime environment, a web server and/or web browser, device drivers, e-mail mailbox reconciliation logic, other applications, etc. System memory 212 also includes program data 222 that is generated and/or used by respective ones of the program modules 212, for example, to provide system 100 with power optimization through datacenter client and workflow resource migration. In this implementation, for example, the program data includes power consumption models 118 (first introduced in FIG. 1), workflow migration instructions 226, estimated power costs 228, and “other program data” 224, for example, such as configurable workflow migration constraints, client/workflow mappings, global data identifiers, and/or so on. We now describe exemplary operations of datacenter 102.

### Exemplary Datacenter Workflow Processing and Migration

As shown in FIG. 2, client computing devices 110, which comprise client applications 112, are operatively coupled to datacenter 102 via network load balancer 202. Although such client computing devices are shown external to the datacenter, in one implementation, one or more of the client computing devices are internal to the datacenter (e.g., for requesting internal datacenter workflows, administration, etc.). The network load balancer receives inputs 114 from respective ones of the client applications (“clients”) 112. As described above in reference to FIG. 1, in an exemplary implementation the received inputs include one or more arbitrary service requests (e.g., IM requests from IM clients 112, search requests from search clients 112, rendering requests from rendering clients 112, information retrieval/storage requests from a set of clients 112, and/or so on). Responsive to receiving a service request from a client, the network load balancer uses conventional load balancing algorithms to send the request to one or more front-end servers 204. Responsive to receiving a service request, a front-end communicates with partitioning manager 216 to determine how to handle the request. In one implementation, for example, if the received service request is from an IM client, the front-end indicates to the partitioning manager the number of IM clients being handled by the front-end—e.g., I have 10,000 IM clients. (A front-end knows which clients are currently being hosted by it in the datacenter). In view of such client-centric information, the partitioning manager, with help of the datacenter workflow migration manager 218 and corresponding power considerations (described below), either directs the front-end to process the request within the datacenter, or instructs the front-end to migrate the request (the request represents an anticipated workflow) to a different datacenter 102. In one implementation, the partitioning manager also causes one or more back-end servers 206 to migrate data resources 126 associated with the workflow to the different datacenter 102.

For example, in a scenario where partitioning manager 216 directs front-end 204 to locally handle/process (i.e., within the datacenter 102) input 114 from a client 112, the partitioning manager implements conventional lookup services to provide the front-end with the identity (IP addresses) of one or more specific back-end servers 206 to handle the received input. Specifically, the partitioning manager uses known partitioning techniques to create workflow partitions on the one or more back-end servers. Each such partition serves a subset of the requests, e.g., the first partition might handle clients 1-100, the second partition might handle clients 101-200, etc. The front-end then proxies inputs from the client to the one or more back-end servers and corresponding workflow partitions. For example, service requests from client 112-2 are sent to back-end server 206-N (e.g., this is an IP address of a back-end server where communications from the client are sent to determine whether a different IM client 112 is online, off-line, etc.).

In another example, and in contrast to conventional lookup/partitioning services, partitioning manager 216 instructs front-end 204 to migrate a set of datacenter clients 112, and instructs back-end 206 to migrate any resources used to handle a corresponding set of actual or anticipated workflows, to a different datacenter 102. In one implementation, the partitioning manager automatically sends such instructions (i.e., workflow migration instructions 226) to the corresponding front-end(s) and back-end(s). In another implementation, front-end(s) and back-end(s) periodically poll the partitioning manager for such instructions. E.g., the front-end regularly asks the partitioning manager to identify any of its current clients with workflows and/or anticipated workflows that should be migrated to a different datacenter 102. To provide this information to requesting components/logic, the partitioning manager communicates with datacenter workflow migration manager (“migration manager”) 218 to determine if there should be a change with respect to the particular datacenter where a set of the datacenter's clients (associated with a set of actual or anticipated workflows) and any corresponding resources 126 should be connected. More specifically, the partitioning manager sends client-centric information from one or more front-ends 204 to the migration manager. In one implementation, such client-centric information, for example, includes information such as numbers and types of clients 112 being handled by the front-end(s). For purposes of exemplary illustration, such client-centric information is shown as a respective portion of “other program data” 224. The back-end(s) may similarly implement an arbitrary combination of automatically sending instructions and polling.

In one implementation, responsive to migration manager 218 receiving client-centric information from partitioning manager 216, and using: (a) power consumption models 118, (b) power prices information (power prices 120 of FIG. 1), and (c) any administratively defined constraints, the migration manager solves an optimization problem to calculate estimated power costs 228. As described above, the models indicate: (d) prior power consumption by the datacenter to process calibrated (i.e., designed) workflows for numerical ranges of type-differentiated clients; and (e) prior power consumption measurements of other datacenters 102 to process respective workflows for numerical ranges of type-differentiated clients. In one implementation, if power is not available at a particular datacenter, the power price is considered to be infinite. In this implementation, part of the determination by migration manager 218 of whether workflows should be migrated from one datacenter to different datacenter take predetermined constraints into consideration. Such constraints are arbitrary administratively provided data migration constraints. E.g., administratively defined constraints may indicate one or more of: (f) move/migrate clients until some criteria is met (e.g., ensure that the network is not saturated, etc.); (g) even if it is cheap, do not move the stuff; (h) some entity was promised that half of all requests will be processed in X (contractual obligations); (i) policy considerations (e.g., never send any requests to Y); (j) weigh client experience (e.g., user perceived experiences, potential data delays, etc.) more than power considerations/costs are weighed, and/or so on. For purposes of exemplary illustration, such constraints are shown as a respective portion of “other program data” 224.

Calculated estimated power costs 128 include: (a) cost estimates to implement corresponding and/or anticipated workflows at datacenter 102; and (b) cost estimates to implement the corresponding and/or anticipated workflows at one or more different datacenters 102. In this implementation, migration manager 218 implements a simulated annealing optimization strategy to determine, in view of the estimated power costs, whether the costs to implement the workflows at the datacenter are optimal in view of the alternatives. Techniques to perform simulated annealing to locate an approximation of a given function's global optimization in a large search space are known.

If migration manager 218 determines that power can be optimized (e.g., reduced power costs) by directing another datacenter 102 to handle a specific set of workflows and/or anticipated workflows, and if there are no intervening constraints, the migration manager instructs partitioning manager 216 to direct associated front-end(s) 204 to migrate the corresponding clients 112 and to direct associated back-end(s) 206 to migrate any associated workflow data resources 126 to the other datacenter. For purposes of exemplary illustration, a specific set of workflows and/or anticipated workflows for handling by the other datacenter are shown in “other program data” 224 as “List of Workflows and/or Anticipated Workflows (i.e., Clients) to Migrate.” In this implementation, the migration manager does not provide the exact identity of the clients to move (or always send), as the partitioning manager maintains the workflow to client mappings (e.g., please refer to TABLE 2). Rather, a migration manager provides the partitioning manager with a total number of clients to move to the new datacenter. In one implementation, the partitioning manager instructs the corresponding front-ends of the specific clients 112 to redirect to the different datacenter using one or more workflow migration instructions 228. In another implementation, the migration manager provides a list of clients and/or requests to move (or always send) to the different datacenter.

In view of the above, if workflows/inputs for migration are not internal datacenter workflows, front-end(s) 204 notify corresponding client(s) 112 to begin sending requests 114 for the workflows/inputs to the different datacenter. Exemplary techniques to accomplish this are described, for example, in the prior section titled “Exemplary Operations for Client and Workflow Resource Migration.” If the workflow(s) are internal datacenter workflow(s), the front-end(s) are not processing requests from end users, but are instead processing requests generated by some other internal datacenter component, e.g., a service that periodically re-indexes a large amount of crawled web data. In this case, the front end may itself simply start sending the requests to the new datacenter. Although these particular and exemplary requests are no longer requests internal to one datacenter, they are still internal to the set of datacenters—they do not involve clients on end-user computing devices. In both cases, the back-end(s) 206 will be directed to migrate the resources in a manner best suited for that particular back-end (e.g., using HTTP), and to stop/pause/continue processing requests on the data as it is being migrated in a manner that is specific to a particular differentiated workflow type.

When workflow(s) in one datacenter 102 are migrated to a different datacenter 102, the corresponding back-end(s) 206 also transfer any data resources 126 (e.g., databases, calculations, mailboxes, etc.) used to process the workflow(s) to the different datacenter. The general design pattern is to bring client requests to the place where the resources needed to satisfy the client requests are located. In one implementation, for example, workflow resources 126 are one or more of local and remote to the datacenter 102. Exemplary techniques to transfer such data resources to the different datacenter are described, for example, above in the section titled “Exemplary Workflow Resource Transfers.”

### An Exemplary Procedure

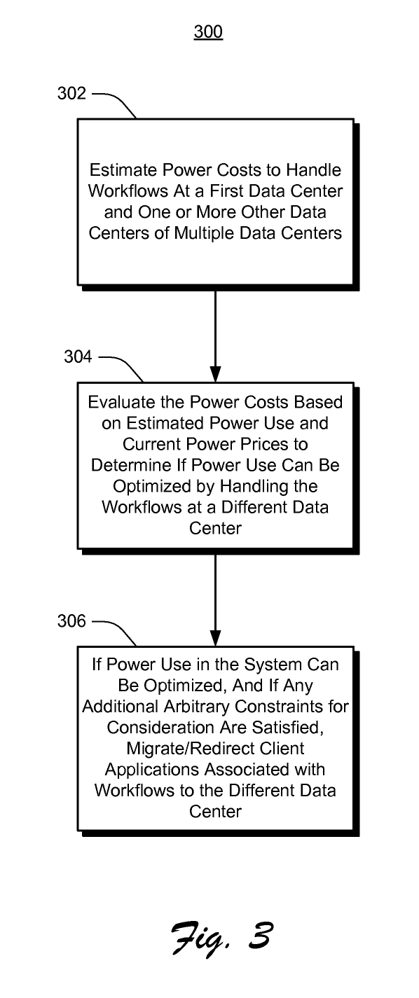

FIG. 3 shows an exemplary procedure 300 for power optimization through datacenter client and workflow resource migration, according to one implementation. For purposes of exemplary illustration and description, operations of procedure 300 are described with respect to aspects of FIGS. 1 and 2. In the description, the left-most numeral of a component reference number indicates the particular figure where the component was first introduced. In one implementation, operations of procedure 300 are implemented by respective computer program modules of computing devices in a datacenter 102 of FIG. 1 and/or FIG. 2.

Referring to FIG. 3, operations of block 302 estimate power costs to handle workflows in a first datacenter and one or more other datacenters of multiple datacenters in a system. In one implementation, for example, workload management server 208 (FIG. 2) calculates estimated power costs 228 to handle actual and/or anticipated workflows in a first datacenter 102 and one or more other datacenters 102. An exemplary first datacenter is shown as a datacenter 102-1 and exemplary other/different datacenters are shown as one or more datacenters 102-2 through 102-N (FIG. 1). In one implementation, estimated power costs are determined for each datacenter by: (a) calculating respective estimated power values/requirements to implement the workflows at the datacenter, and (b) determining the corresponding estimated power costs in view of current power prices. That is, for any one of the datacenters, their respective estimated power cost is based on the datacenter's respective estimated power requirements (power value) to handle the workflows, and an indication of the price of power (e.g., power rates, power prices 120 of FIG. 1) in the geographical region within which the datacenter is located. A datacenter determines the respective power values/requirements by using prior configured power consumption models 118. The power consumption models indicate previously measured power actually consumed by the datacenter and by other datacenters to process workflows for specific numbers of type-differentiated client applications. (Aspects of the power consumption models are described above in the section titled “Exemplary Power Consumption Models.”) Once the datacenter currently handling the workflows determines the respective estimated power values for each datacenter, the datacenter than calculates respective estimated power costs for each datacenter to implement the workflows. Techniques to calculate such power costs are described above in the section titled “Exemplary Workflow Power Cost Estimations.”

Operations of block 304 compare/evaluate the calculated estimated power costs (e.g., estimated power cost 228 of FIG. 2) to handle the workflows. This evaluation is performed to determine whether power use in the system can be optimized by logically moving the workflows from the datacenter currently handling the workflows to a different datacenter. In one implementation, for example, workload management server 208 implements these evaluation operations using simulated annealing algorithms. If it is determined that power use in the system can be optimized, and if any additional arbitrary constraints for consideration are satisfied, operations of block 306 migrate client applications 112 associated with the workflows to the different datacenter. In this implementation, when a client application is migrated to a different datacenter, the client application is directly or indirectly instructed to send any service requests 114 corresponding to the workflows to the different datacenter. Any other constraints involved in making the determination of whether to migrate to client applications to the different datacenter are arbitrary. For example, such constraints may include prior contractual obligations, policy, etc.

In one implementation, if the different datacenter does not have ready access to data resources 126 associated with the workflows for migration, operations of block 306 further include transferring the data resources from the datacenter currently handling the workflows to the different datacenter targeted to handle the workflows. In one implementation, the operations of block 306 are performed by corresponding logic in a combination of components. Such components include, for example referring to FIG. 2, datacenter workflow migration manager 218, a partitioning manager 216, front-end servers 204, back-end servers 206, and/or network load balancing logic 202.

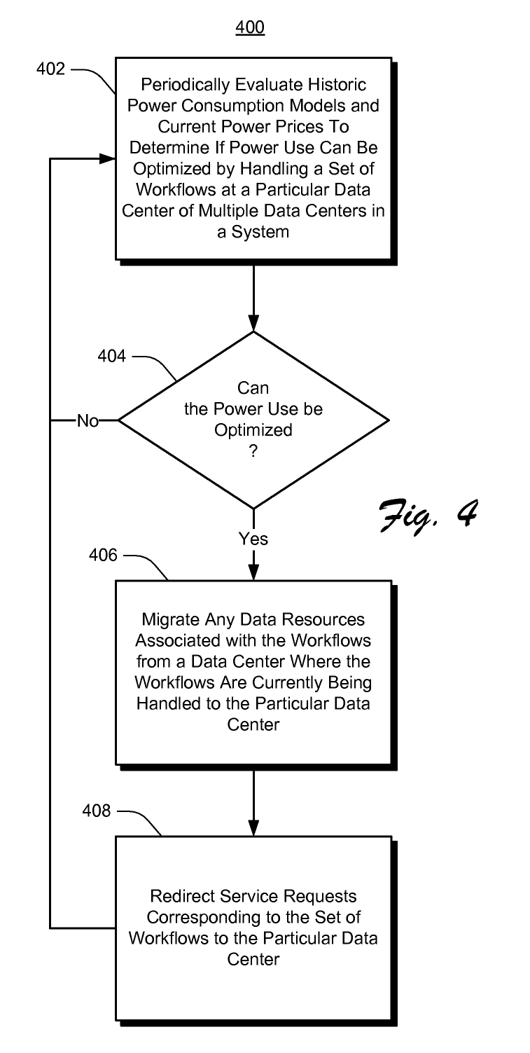

FIG. 4 shows another exemplary procedure 400 for power optimization through datacenter client and workflow resource migration, according to one implementation. For purposes of exemplary illustration and description, operations of procedure 400 are described with respect to aspects of FIGS. 1 and 2. In the description, the left-most numeral of a component reference number indicates the particular figure where the component was first introduced. In one implementation, operations of the procedure are implemented by respective computer program modules of computing devices in datacenter(s) 102 of FIG. 1 and/or FIG. 2.

Operations of block 402 periodically evaluate historic power consumption models 118 and current power prices 120 to determine if power use can be optimized by handling a set of workflows 116 at a particular datacenter 102 of multiple datacenters 102 in a system 100. In one implementation, such evaluations are responsive to one or more of: receipt of service request(s) 114 from one or more client applications 112, elapse of a predetermined time interval, responsive to environmental factors, datacenter power use in view of pre-configured power use thresholds, network throughput criteria, policy, and/or so on. In one implementation, operations of block 402 are performed by datacenter workflow migration management logic (e.g., datacenter workflow migration manager 218).

At block 404, if power use in the system can be optimized (e.g., power costs are estimated to be less expensive, etc.) by logically migrating the workflows from a first datacenter 102 to a different datacenter 102, operations continue at block 406. Otherwise, operations continue at block 402 as described above. In one implementation, workflow migration manager 218 directs partitioning manager 216 to migrate the workflows to the particular datacenter. Responsive to receipt of such instructions, the partitioning manager maps the specific workflows to one or more workflow resources 126 and corresponding client applications 112. Operations of block 406 migrate any data resources 126 associated with the set of workflows from the datacenter 102 where the workflows are currently being handled, to the particular datacenter 102 identified in the operations of block 402. In one implementation, the partitioning manager directs front-end servers 204 to instruct corresponding back-end servers 206 to transfer the data resources to the particular datacenter. Operations of block 408 directly or indirectly instruct the one more client applications to send service requests 114 associated with the specific workloads to the particular datacenter. In one implementation, the partitioning manager instructs the corresponding front-end servers 204 to migrate service requests from the mapped client applications to the particular datacenter.

### CONCLUSION

Although the above sections describe power optimization through datacenter client and workflow resource migration in language specific to structural features and/or methodological operations or actions, the implementations defined in the appended claims are not necessarily limited to the specific features or actions described. Rather, the specific features and operations for power optimization through datacenter client and workflow resource migration are disclosed as exemplary forms of implementing the claimed subject matter.

1. In a system comprising multiple datacenters, a method implemented at least in part by a computing device in a first datacenter of the multiple datacenters, the method comprising:
estimating power costs to handle workflow(s) at the first datacenter and one or more other datacenters of the multiple datacenters;
evaluating the power costs to determine whether power use in the system can be optimized by handling the workflow(s) at a different datacenter of the other datacenters, power use optimization in the system comprising one or more of use of a more efficient resource to handle the workflow(s) and executing the workflow(s) where power is less costly; and
if power use in the system can be optimized by handling the workflow(s) at the different datacenter, and if any additional constraint(s) for consideration are satisfied, migrating client application(s) associated with the workflow(s) to the different datacenter.

2. The method of claim 1, wherein the workflow(s) comprise workflow(s) being handled by the first datacenter and anticipated workflow(s) at the first datacenter.

3. The method of claim 1, wherein the additional constraint(s) comprise a null set of constraints or constraints based on one or more of prior contractual agreement(s), policy, performance, end-user experience, end-user preference, and other arbitrary constraint(s).

4. The method of claim 1, wherein estimating the power costs further comprises:
for each datacenter of the first datacenter and the one or more other datacenters:
calculating a respective power value to implement the workflow(s) at the datacenter, the respective power value being based on prior measured power consumed at the datacenter to process workflows for specific numbers of type-differentiated client applications; and
determining a respective power cost based on the respective power value and an indication of a power price in a geographical area within which the datacenter is located.

5. The method of claim 1, wherein estimating the power costs further comprises, for each datacenter of the first datacenter and the one or more other datacenters:
maintaining a respective power consumption model, the power consumption model indicating:
(a) a first set of data indicating actual historical power consumption of the datacenter to process workflows for particular numbers of type-differentiated client applications; and
(b) a second set of data indicating actual historical power consumption of the one or more other datacenters to process workflows for specific numbers of type-differentiated client applications; and
calculating the power costs to handle the workflow(s) for a current number of type-differentiated client applications based on the first and second sets of data.

6. The method of claim 5, wherein calculating further comprises, if the current number of type-differentiated client applications is not equal to indicated numbers of type-differentiated client applications upon which historical power consumption information in the power consumption model is based, extrapolating the power costs from the historical power consumption information.

7. The method of claim 1, wherein the method further comprises:
identifying the client application(s); and
wherein migrating the client application(s) further comprises redirecting the client application(s) to communicate service request(s) corresponding to the workflow(s) to the different datacenter.

8. The method of claim 1, further comprising:
identifying data resources for the workflow(s); and
transferring the data resources from the first datacenter to the different datacenter to facilitate handling, by the different datacenter, of the workflows.

9. The method of claim 8, wherein the data resource(s) comprise one or more of a database, calculation(s), an e-mail mailbox, a user space, a webpage, and data not exposed to user(s) of the client application(s).

10. A computer-readable data storage medium having computer-program instructions encoded thereon, the computer-program instructions being executable by a processor for performing datacenter workflow migration operations comprising:
evaluating historic power consumption models and power prices corresponding to respective ones of multiple datacenters to determine if power use can be optimized by handling a specific set of workflows at a particular datacenter of the multiple datacenters;
if the power use can be optimized and if the specific set of workflows is not currently being handled by the particular datacenter:
migrating any data resource(s) associated with the specific set of workflows from a datacenter of the multiple datacenters to the particular datacenter, the specific set of workflows currently being handled by the datacenter; and
redirecting service requests corresponding to the specific set of workflows to the particular datacenter.

11. The computer-readable medium of claim 10, wherein power use is optimized if it is less expensive to implement the specific set of workflows at the particular datacenter.

12. The computer-readable medium of claim 10, wherein the service requests are from client applications that are one or more of external to the datacenter and internal to the datacenter.

13. The computer-readable medium of claim 10, wherein the datacenter workflow migration operations are implemented by a combination of distributed logic comprising workflow power cost determination and optimization logic, partitioning manager logic, back-end logic and front-end logic.

14. The computer-readable medium of claim 10, wherein the historic power consumption models for each datacenter of the multiple datacenters comprises a first set of data indicating actual historical power consumption of the datacenter to process workflows for particular numbers of type-differentiated client applications, and a second set of data indicating actual historical power consumption of the one or more other datacenters to process workflows for specific numbers of type-differentiated client applications.

15. The computer-readable medium of claim 14, wherein the type-differentiated clients comprise one or more of instant messaging clients, search clients, browser clients, and page rendering and caching clients.

16. The computer-readable medium of claim 10, wherein operations for the migrating and the redirecting are performed only if predetermined constraint(s) independent of optimizing power use are satisfied.

17. The computer-readable medium of claim 10, wherein the operations further comprise operations for receiving, from one or more data feeds, the power prices, the power prices indicating price rates for power at geographical locations of respective datacenters of the multiple datacenters.

18. A system for optimizing power in a system of datacenters, the system being implemented on one or more computing devices comprising workflow migration management logic, partitioning manager logic, back-end logic and front-end logic, and wherein:
the workflow migration management logic is configured to:
(a) estimate power costs to handle workflow(s) at a first datacenter of the datacenters and one or more other datacenters of the datacenters;
(b) evaluate the power costs to determine whether power use in the system can be optimized by handling the workflow(s) at a different datacenter of the other datacenters; and
(c) if power use in the system can be optimized by handling the workflow(s) at the different datacenter, and if any additional constraint(s) for consideration are satisfied, directing partitioning manager logic to migrate the workflow(s) to the different datacenter; and
the partitioning manager logic, responsive to receiving directions to migrate the workflow(s), being configured to:
(d) map the workflow(s) to one or more client applications;
(e) direct the front-end logic to redirect the one or more client applications to send service request(s) corresponding to the workflow(s) to the different datacenter, and direct the back-end logic to move any data resource(s) corresponding to the workflow(s) that are not already available to the different datacenter, to the different datacenter; and
(f) clean-up the workflow(s) at the first datacenter.

19. The system of claim 18, wherein each datacenter of datacenters maintains a respective power consumption model, the power consumption model having been pre-configured by an administrative entity to indicate:
(a) a first set of data indicating actual historical power consumption measurements of the datacenter to process workflows for particular numbers of type-differentiated client applications; and
(b) a second set of data indicating actual historical power consumption measurements of the one or more other datacenters to process workflows for specific numbers of type-differentiated client applications; and
wherein the workflow migration management logic is further configured to estimate the power costs based on the first and second sets of data.

20. The system of claim 18, wherein the workflow migration management logic is further configured to estimate the power costs by linearly extrapolating power use measurements indicated by the first and second sets of data.
